(19) United States
(12) Patent Application Publication
(10) Pub. No.: US 2010/0267367 A1
(43) Pub. Date: Oct. 21, 2010

(54) METHODS AND APPARATUS FOR AUTOMATIC CONTACT DATA UPDATING

(75) Inventors: Ted Booth, San Diego, CA (US); Yasuhiro Habara, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: Sony Corporation, Tokyo (JP); Sony Electronics, Inc., Park Ridge, NJ (US)

(21) Appl. No.: 12/426,117

(22) Filed: Apr. 17, 2009

(51) Int. Cl. H04M 3/42; G06F 17/30

(52) U.S. Cl. 455/414.1

(57) ABSTRACT

Methods and systems for updating a contact list for a cellular phone or wireless device, the contact list comprising a plurality of individual contacts each comprising data relating to an individual cellular phone number. The method includes the steps of identifying an individual cellular phone number for updating into the contact list, sending from the user's cellular phone a request for electronic data associated with the cellular phone number to a device operating under the cellular phone number, receiving the request at the device, sending a reply message having the requested electronic data from the device, receiving the reply message at the user's cellular phone, and updating the contact list by associating the electronic data to the individual cellular phone number.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to cellular communications, and more particularly to contact data updating.

2. Description of Related Art

Currently, when a new contact is added to an address book/contact application, the user can have the ability to add/assign a photo to this contact. Sometimes the user may already have a photo of that person stored somewhere (e.g. local storage, external media, networked storage, etc.). When the user does not have a photo of this new contact they must remember to get one, which can include communicating to that person that they want a photo of them, remembering to take a picture with some camera-enabled device and associated media when they are co-located with the new contact.

Accordingly, an object of the present invention is to provide system and methods for automatically updating digital data associated with a contact in a contacts list. At least some of these objectives will be met in the description detailed below.

### BRIEF SUMMARY OF THE INVENTION

An aspect of the invention is a method of updating a contact list for a user's cellular phone (or other wireless device operating over a wireless network), wherein the contact list comprises a plurality of individual contacts each comprising data relating to an individual cellular phone number (or wireless device identity). The method includes the steps of identifying an individual cellular phone number (wireless device identity) for updating into the contact list, sending from the user's cellular phone a request for electronic data associated with the cellular phone number to a device operating under the cellular phone number, receiving the request at the device, sending a reply message having the requested electronic data from the device, receiving the reply message at the user's cellular phone, and updating the contact list by associating the electronic data to the individual cellular phone number.

In a similar fashion, the method of updating a contact list may be applied to any wireless device operating over a wireless network (e.g. laptop operating over a data line), wherein the contact list comprises a plurality of individual contacts each comprising data relating to wireless device identity (e.g. email ID). The method includes the steps of identifying an individual wireless device identity for updating into the contact list, sending from the user's device a request for electronic data associated with the wireless device identity to a second device operating under the wireless device identity, receiving the request at the second device, sending a reply message having the requested electronic data from the second device, receiving the reply message at the user's device, and updating the contact list by associating the electronic data to the individual wireless device identity.

In one embodiment, the electronic data comprises a picture (e.g. photo in jpeg format) associated with the individual cellular phone number. In one mode, the picture is automatically uploaded to the reply message from a stored photo on the device. In another mode the request for electronic data is automatically generated from the cellular phone. The cellular phone may further provide a user prompt (e.g. asking if the user would like to send the picture) prior to sending the electronic data.

In one embodiment, the request for electronic data is compatible with, but not limited to, one or more of the following protocols: SMS, MMS, email, DIAS.

In another embodiment, identifying an individual cellular phone number for updating into the contact list comprises: receiving a call on the cellular phone from a cellular phone number not associated with a contact in the contact list; and prompting the user to add the cellular phone number to contact list. The user may also be prompted to request a picture associated with the cellular phone number.

In another embodiment, the electronic data comprises one or more of the following: a picture, music, sound, video or text file associated with the individual cellular phone number.

Another aspect is computer-readable medium containing instructions for controlling a cellular phone to automatically perform a method, the cellular phone including at least one processor for executing the instructions, wherein the method includes the steps of: identifying an individual cellular phone number for updating into the contact list; sending from the user's cellular phone a request for electronic data associated with the cellular phone number to a device operating under the cellular phone number; receiving the request at the device; sending a reply message from the device, the reply message comprising the requested electronic data; receiving the reply message at the user's cellular phone; and updating the contact list by associating the electronic data to the individual cellular phone number.

Another aspect is a communication system comprising first and second cellular phones in communication over a network, wherein the first and second cellular phones having a contact application software configured to assimilate data with respect to a plurality of individual cellular phone numbers in a contact list. The contact application software comprises a transmitting module for generating a request for electronic data associated with an individual cellular phone number and a receiving module for reading the request for electronic data and associating the electronic data to an individual cellular phone number in the contact list.

In one embodiment, the electronic data comprises a picture associated with the individual cellular phone number. In one mode, the transmitting module is configured to transmit a picture request to a user of the second phone, and the receiving module on the second phone is configured to automatically upload the picture for transmission back to the first phone. The transmitting module on the second phone may further be configured to transmit the picture in a reply message back to the first phone. Additionally, the receiving module on the first phone may be configured to upload the picture to memory located on the first cellular phone and associate the picture to the individual cellular phone number. The receiving module may be configured to automatically upload the picture to the reply message from a stored picture on the second phone.

In one embodiment, the transmitting module is configured to format the electronic data request according to one or more of the following protocols: SMS, MMS, email, DIAS. In another embodiment, the receiving module is configured to read the electronic data request formatted in one or more of the following protocols: SMS, MMS, email, DIAS.

In another embodiment, the contact application includes an interface module configured to interface between the receiving module, transmitting module, and data in the contact list.

Another aspect is a contacts application for organizing data in a contact list for first and second cellular phones in communication over a network, the contact list comprising a plurality of individual cellular phone numbers. The application comprises: a transmitting module for generating a request for electronic data associated with an individual cellular phone number; and a receiving module for reading a reply message comprising the requested electronic data and uploading the picture to memory located on the cellular phone and associate the electronic data to the individual cellular phone number.

In one embodiment, the transmitting module is configured to transmit a picture request from the first phone to the second phone, and the receiving module on the second phone is configured to automatically upload the picture for transmission back to the first phone.

In another embodiment the transmitting module on the second phone is configured to transmit the picture in a reply message back to the first phone.

The receiving module may also be configured to automatically upload the picture to the reply message from a stored picture on the second phone.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates an exemplary phone network in accordance with the present invention.

FIG. 2 illustrates the individual components of a cell phone in accordance with the present invention.

FIG. 3 illustrates a flowchart showing a method in accordance with the present invention for automatically updating contact information from a caller number that is not stored in contact list.

FIG. 4 illustrates a method for receiving and analyzing a photo request in accordance with the present invention.

FIG. 5 illustrates a method in accordance with the present invention for automatically updating contact information from a caller number that is already stored in contact list.

FIG. 6 illustrates an exemplary configuration for contact application software in accordance with the present invention.

### DETAILED DESCRIPTION OF THE INVENTION

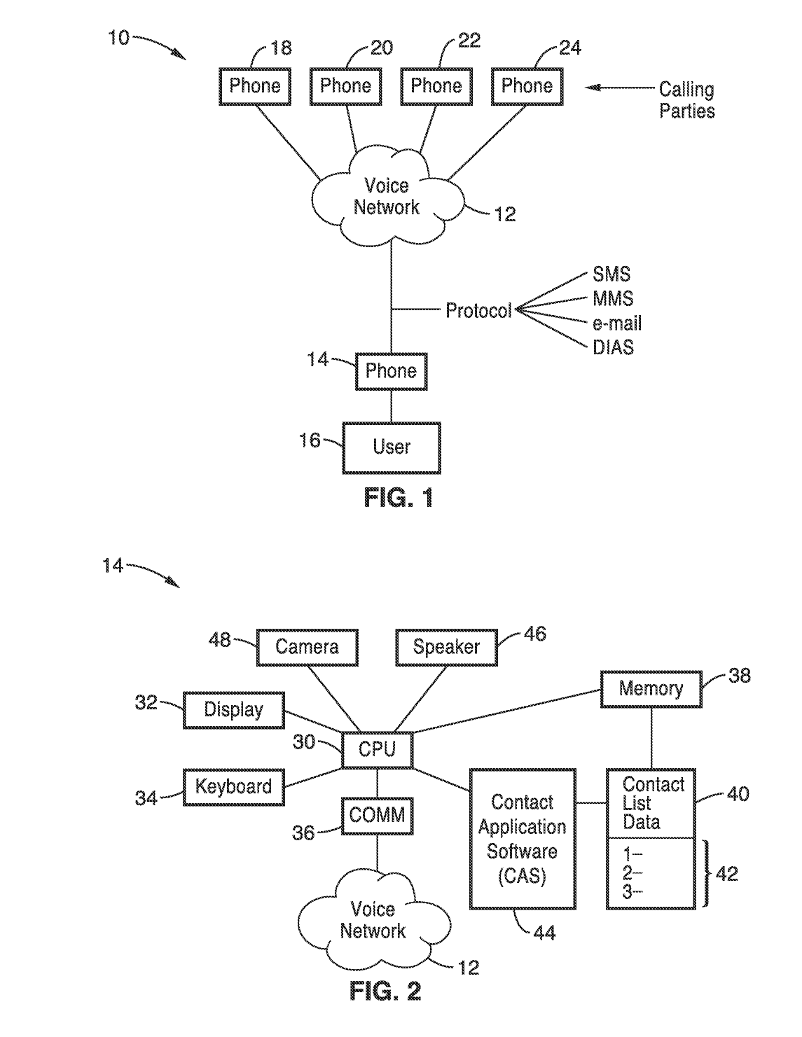

Referring more specifically to the drawings, for illustrative purposes the present invention is embodied in the apparatus generally shown in FIG. 1 through FIG. 6. It will be appreciated that the apparatus may vary as to configuration and as to details of the parts, and that the method may vary as to the specific steps and sequence, without departing from the basic concepts as disclosed herein.

FIG. 1 illustrates a communication system 10 in accordance with the present invention. A receiving party 16 having a cellular phone 14 may receive a call, (or dial an outgoing call to), from any number of calling party phones, e.g. phones 18, 20, 22, and 24. The incoming/outgoing calls are made over voice network 12, and may comprise any one of a number of different protocols, e.g. short message service (SMS), enhanced message service (EMS), multimedia messaging service (MMS), short message peer-to-peer (SMPP), email, http, DIAS, etc.

Although FIG. 1 and the remaining figures illustrate use of cellular phones over a voice network 12, it is appreciated that the systems and methods of the present invention may be implemented over any wireless network, and with a multitude of different wireless devices (e.g. personal computer or the like). For example, a laptop (which would operate in a similar fashion as wireless device 14) may be enabled with embedded Wireless WAN to operate over wireless network 12. Wireless device 14 may also be configured to operate under IP-based networks such as WiMAX and LTE.

FIG. 2 illustrates with the individual components of a cell phone 14 in accordance with the present invention. Cell phone 14 interfaces with voice network 12 via a communication module 36. The communication module 36, memory 38, display 32, keyboard 34, speaker 46, and camera 48 are all coupled to processor 30 for general operation of the phone. The phone 14 will also comprise contact application software (CAS) 44 that manages data for a contact list 40 comprising one or more contacts 42. The contact application software (CAS) 44 may be included within the general software stored on the phone 14, or may be a separate module dedicated to managing the contact list data 40.

Memory 38 may also store other data, such as music (e.g. mp3's) sounds (e.g. wav files), pictures (e.g. jpeg's), video (e.g. avi, mpeg, WMV, etc.), documents, text, preferences, etc. The contact application software (CAS) 44 interfaces with the memory module 38 on the phone to store, retrieve, and/or associate photos or other digital information to contacts 42 in the contact list 40.

Although the contact application software (CAS) 44 may be accessed by the user to manually assign or associate digital information stored in memory 38 to various contacts, a particularly advantageous aspect of the present invention is automatic updating/association of digital information with one or more contacts stored in memory 38.

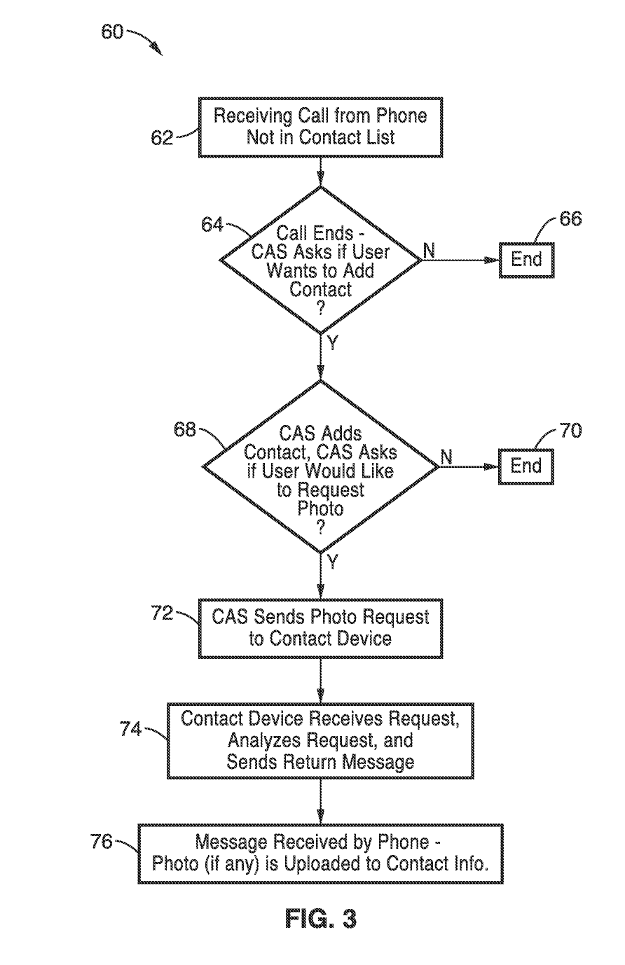

FIG. 3 illustrates a flowchart showing a method 60 in accordance with the present invention for automatically updating contact information from a caller number that is not stored in contact list 40. First, at step 62, the phone 14 receives a call or text from a phone (e.g. from one of callers 18-24) that has a phone number not associated with any contacts 42 in the contact list 40.

At step 64 when the call ends (or after reading the text), the contact application software (CAS) 44 initiates a message on display 32 asking the user 16 if the user wants to add contact information to the new number. In the case of an email message, the electronic identity of the wireless device (e.g. email ID) may also show up as not affiliated with any contact in the contact list. The contact information, and subsequently retrieved digital data described in further detail below, could then be associated with the device's wireless identity (e.g. associated to the email ID instead of phone number).

If the user replies “no” (this may be an assigned button or keypad corresponding to the displayed message), the application ends at step 66.

If the user responds “yes,” the contact information is added and assigned to the number at step 68 (this may be done manually by the user via the keypad, or automatically if caller's identity were already programmed to the message/call). The contact application software (CAS) 44 also sends a message verifying if the user 16 would like to request a photo from the caller.

It is appreciated that other electronic data may also be requested, e.g. a ring tone, ring-back tone, electronic business card, etc.

If the user responds “no,” the contact is stored in memory and contacts application ends at step 70. If the user responds “yes,” the CAS 44 sends a photo request to the calling party device (e.g. phone 18) at step 72.

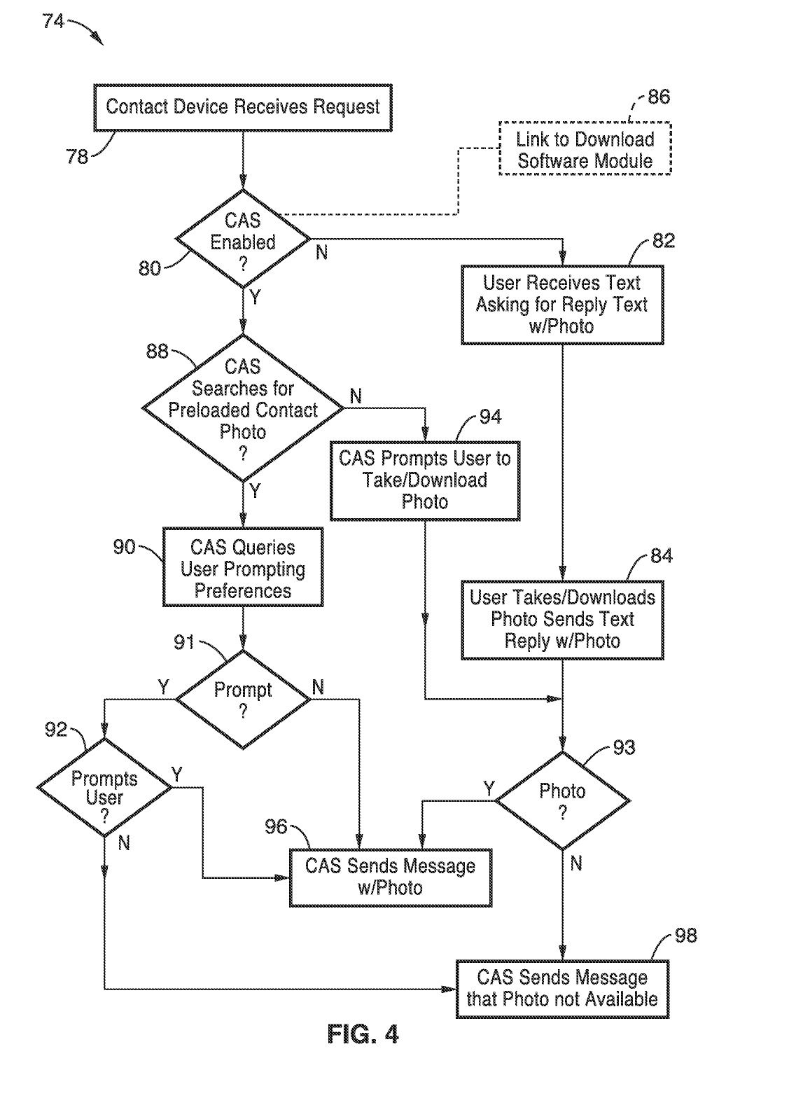

The calling party device (e.g. phone 18) receives the request, analyzes the request and sends return message at step 74. Depending on the type and protocol of the device 18, step 74 may comprise a programmed routine for performing the request, as detailed further below with respect to FIG. 4.

At step 76, the message is received by the phone 14, and the photo (if any) is uploaded to memory 38 and assigned to the contact 42.

FIG. 4 illustrates the method of step 74 in more detail. The contact updating method of the present invention may be configured so that it may interface only with like phones (e.g. between users of DIAS or smart phones.) Alternatively, the contact application software (CAS) 44 may be configured such that the user's phone can automatically interface with any phone, regardless of the platform or protocol that it uses.

For example, the request formatting/data and protocol used may operate over different network connections, (e.g. LAN, WAN, etc.) and each of these connections may support multiple network and communications protocols (e.g. WWAN: http, SMS, MMS, DIAS, etc. WLAN: http, DIAS, etc.) Generally, the contact application software (CAS) 44 may be configured to work with any device (e.g. DIAS, Windows Mobile, SMS, email, etc.) that supports an address book/contacts application and is configured to be connected to a network (e.g. voice network 12). The contact application software (CAS) 44 is shown as a client-based in FIG. 2. However, it may also be implemented as a server-based or client/server based application as well.

Accordingly, the photo request message 72 may be configured and/or customized so that it is enabled to communicate with a specific type of device (e.g. only between a DIAS device and another DIAS device), or to communicate between a number of different devices. In the latter embodiment, the request message 72 may be customized to have instructions that are readable from an SMS, MMS, email, DIAS, or other protocol enabled phone. Generally, the lowest common denominator from the above protocols would be SMS, i.e. any phone would at least have compatibility to read the SMS message. However, additional instruction may be customized into the request message 72 that is readable in different protocol to take advantage of the benefits that that protocol provides.

Step 74 in FIG. 4 illustrates how a phone receives and applies a message request in accordance with the present invention. In the embodiment shown in FIG. 4, the phone 18 or contact application software (CAS) 44 is enabled receive the incoming request message regardless of the type of device or protocol used by the device 18.

In step 78, the device 18 receives the request, and depending on whether the device 18 has the capability or proper contact application software (CAS) 44 installed (step 80), the device may automatically retrieve the photo or other requested digital data (step 88), or initiate a manual process by the user (step 82).

The request message 74 may also be optionally configured such that if compatible contact application software (CAS) 44 is not presently loaded on the device 18, that a message be sent in step 86 to the user offering a link, quick dial, or the like to download the software as a patch or upgrade to the existing software on the device 18. The user could then download the software to the new device, which automatically installs and upgrades the phone. Without compatible software, the device 18 will receive a text message asking user to upload a photo to send in a reply text at step 82. The user can then take a photo (e.g. from the phone's camera 48), or use a preloaded photo to attach to the reply text and send back to user 14 at step 84.

For a CAS enabled device 18, the CAS 44 will first search for a preloaded contact photo, e.g. “My Photo,” at step 88. If the user has already uploaded a photo, the CAS 44 will query the user's preferences at step 90 to determine whether the user has requested a prompt before automatically sending out the photo or other digital information at step 96. If the user has asked for a prompt, the CAS will prompt the user of phone 18 that user 16 of phone 14 has requested his/her photo. The user of phone 18 may then hit a designated button or key to send the photo at step 96, or send a message that a photo is not available at step 98.

When a CAS enabled device does not have a designated contact photo uploaded, the CAS will prompt the user to take/download and or designate a photo at step 94. The CAS 44 may be configured to perform special handling to activate camera, if available. If the user of phone 18 decides to upload and/or designate a photo, the CAS automatically sends a return message at step 96. If the user decides not to upload the photo, the CAS sends a reply message that a photo is not available (step 98).

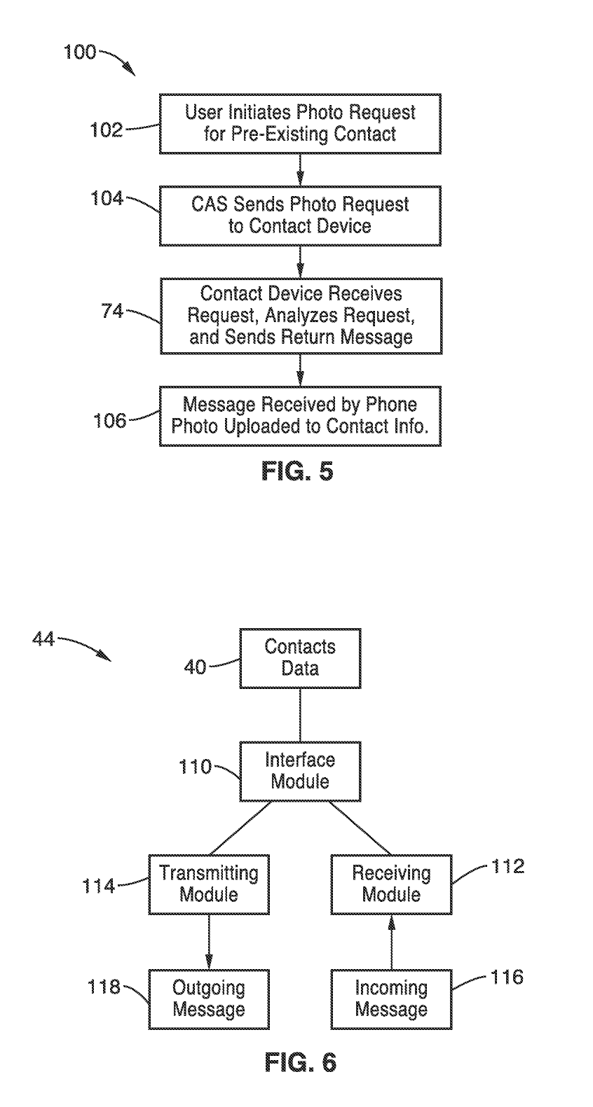

FIG. 5 illustrates showing a method 60 in accordance with the present invention for automatically updating contact information from a caller number that is stored in contact list 40, (i.e. an existing contact without photo). At step 102, user 16 of phone 14 sees a contact entry has no photo (or the phone 14 receives a call from an existing contact) and thus the user 16 initiates a contact photo request. The CAS 44 then sends a contact photo request to the associated contact at step 104. At step 74, the contact receives contact photo request, takes and/or uploads the photo and sends the photo back to user 16. As shown in FIG. 4, step 74 may comprise an automated process, or a manual upload from the contact. In step 106, the user device receives contact photo response and automatically adds/associates the photo to new contact.

FIG. 6 illustrates an exemplary configuration for contact application software (CAS) 44 in accordance with the present invention. The contacts application will preferably comprise a transmitting module 114 and receiving module that interface with contacts data 40 (which may be stored in memory 38 with other digital data such as mp3's mpegs, wav files, etc.) via interface module 110.

The receiving module 112 comprises code that is configured to interpret an incoming message 116 according to the device's 14 highest available protocol. The receiving module is preferably configured to analyze the message and perform auto-retrieve and user prompting functions as detailed in step 74 of FIG. 4. When receiving a reply message (e.g. to a photo or other data request in steps 76 and 106 in FIGS. 3 and 4 respectively) the receiving module is configured to automatically upload the photo (or other digital data) to the phone's (14) memory 38, and associate the photo to the corresponding contact 42 in the contact list 40. Thus, the next time a call is received by the phone number corresponding to the contact 42, their picture appears in display 32 (along with their name, etc.). Accordingly, if other digital data is retrieved, (e.g. ring tone, etc.), it can also be uploaded to memory 38 and associated with the contact 42 so that the digital file (mp3, wav or the like) is played out speaker 46 when that contact is calling or being called.

The transmitting module 114 is configured to transmit specially formatted outgoing messages 118, e.g. contact photo requests (see step 72 in FIG. 3), send reply messages with the requested photos in response to other phone's (e.g. phone 18) requests, etc. The outgoing message may be specially formatted in a particular protocol or in a plurality of protocols so that the message may be received by any caller, regardless of the type of phone they use.

The contacts application may also contain functionality for automatically updating “My Photo”, even when a previous photo has been sent to a contact. The software may be configured to update according to settings in the user's preferences, e.g. send an update out to the entire contact list allowing the contacts the option to update to the new photo. If GEO tag info is embedded in the photo, it can automatically be stored in the contact info as well.

The present invention, as detailed above, provides a number of benefits and advantages, including: encouraging social interaction and content sharing; maximizing ease of requesting and adding photos to contacts, especially if device has “unlimited data plan” capability; creating a more highly personalized device user experience in contacts and other applications using a contact's photo.

As can be seen, therefore, the present invention includes the following inventive embodiments among others:

1. A method of updating a contact list for a user's cellular phone, the contact list comprising a plurality of individual contacts each comprising data relating to an individual cellular phone number, comprising:

identifying an individual cellular phone number for updating into the contact list; sending from the user's cellular phone a request for electronic data associated with the cellular phone number to a device operating under said cellular phone number;

receiving said request at said device;

sending a reply message from said device, said reply message comprising said requested electronic data;

receiving said reply message at said user's cellular phone; and

updating said contact list by associating said electronic data to the individual cellular phone number.

2. A method as recited in embodiment 1, wherein the electronic data comprises a picture associated with the individual cellular phone number.

3. A method as recited in embodiment 2, wherein the picture is automatically uploaded to the reply message from a stored photo on the device.

4. A method as recited in embodiment 2, wherein the request for electronic data is automatically generated from the cellular phone.

5. A method as recited in embodiment 4, wherein the cellular phone provides a user prompt prior to sending the electronic data.

6. A method as recited in embodiment 4, wherein the request for electronic data is compatible with one or more of the following protocols: SMS, MMS, email, DIAS.

7. A method as recited in embodiment 1, wherein identifying an individual cellular phone number for updating into the contact list comprises:

receiving a call on said cellular phone from a cellular phone number not associated with a contact in the contact list; and

prompting the user to add said cellular phone number to contact list.

8. A method as recited in embodiment 7, further comprising:

prompting the user to request a picture associated with the cellular phone number.

9. A method as recited in embodiment 1, wherein the electronic data comprises one or more of the following: a picture, music, sound, video or text file associated with the individual cellular phone number.

10. A computer-readable medium containing instructions for controlling a cellular phone to automatically perform a method, the cellular phone including at least one processor for executing the instructions, the method comprising:

identifying an individual cellular phone number for updating into the contact list;

sending from the user's cellular phone a request for electronic data associated with the cellular phone number to a device operating under said cellular phone number;

receiving said request at said device;

sending a reply message from said device, said reply message comprising said requested electronic data;

receiving said reply message at said user's cellular phone; and

updating said contact list by associating said electronic data to the individual cellular phone number.

11. A computer-readable medium as recited in embodiment 10, wherein the electronic data comprises a picture associated with the individual cellular phone number.

12. A computer-readable medium as recited in embodiment 11, wherein the instructions are configured such that the picture is automatically uploaded to the reply message from a stored photo on the device.

13. A computer-readable medium as recited in embodiment 12, wherein the instructions are configured such that the request for electronic data is automatically generated from the cellular phone.

14. A communication system comprising:

a first cellular phone;

a second cellular phone in communication with the first cellular phone over a network;

said first and second cellular phones having a contact application software configured to assimilate data with respect to a plurality of individual cellular phone numbers in a contact list;

the contact application software comprising:
a transmitting module for generating a request for electronic data associated with an individual cellular phone number; and
a receiving module for reading the request for electronic data and associating the electronic data to an individual cellular phone number in the contact list.

15. A system as recited in embodiment 14:

wherein the electronic data comprises a picture file associated with the individual cellular phone number.

16. A system as recited in embodiment 14, wherein the electronic data comprises one or more of the following: a picture, music, sound, video or text file associated with the individual cellular phone number.

17. A system as recited in embodiment 15:

wherein the transmitting module is configured to transmit a picture request to a user of the second phone; and

wherein the receiving module on the second phone is configured to automatically upload the picture for transmission back to the first phone.

18. A system as recited in embodiment 17, wherein the transmitting module on the second phone is configured to transmit the picture in a reply message back to the first phone.

19. A system as recited in embodiment 18, wherein the receiving module on the first phone is configured to upload the picture to memory located on the first cellular phone and associate the picture to the individual cellular phone number.

20. A system as recited in embodiment 17, wherein the receiving module is configured to automatically upload the picture to the reply message from a stored picture on the second phone.

21. A system as recited in embodiment 14, wherein the transmitting module is configured to format the electronic data request according to one or more of the following protocols: SMS, MMS, email, DIAS.

22. A system as recited in embodiment 14, wherein the receiving module is configured to read the electronic data request formatted in one or more of the following protocols: SMS, MMS, email, DIAS.

23. A system as recited in embodiment 14, further comprising:

an interface module;

said interface module configured to interface between the receiving module, transmitting module, and data in the contact list.

24. A contacts application for organizing data in a contact list for first and second cellular phones in communication over a network, the contact list comprising a plurality of individual cellular phone numbers, the application comprising:

a transmitting module for generating a request for electronic data associated with an individual cellular phone number; and

a receiving module for reading a reply message comprising the requested electronic data and uploading the picture to memory located on the cellular phone and associate the electronic data to the individual cellular phone number.

25. A contacts application as recited in embodiment 24, wherein the electronic data comprises a picture associated with the individual cellular phone number.

26. A contacts application as recited in embodiment 24, wherein the electronic data comprises one or more of the following: a picture, music, sound, video or text file associated with the individual cellular phone number.

27. A contacts application as recited in embodiment 24: wherein the transmitting module is configured to transmit a picture request from the first phone to the second phone; and wherein the receiving module on the second phone is configured to automatically upload the picture for transmission back to the first phone.

28. A contacts application as recited in embodiment 27, wherein the transmitting module on the second phone is configured to transmit the picture in a reply message back to the first phone.

29. A contacts application as recited in embodiment 27, wherein the receiving module is configured to automatically upload the picture to the reply message from a stored picture on the second phone.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of updating a contact list for a user's cellular phone, the contact list comprising a plurality of individual contacts each comprising data relating to an individual cellular phone number, comprising:
identifying an individual cellular phone number for updating into the contact list;
sending from the user's cellular phone a request for electronic data associated with the cellular phone number to a device operating under said cellular phone number;
receiving said request at said device;
sending a reply message from said device, said reply message comprising said requested electronic data;
receiving said reply message at said user's cellular phone; and
updating said contact list by associating said electronic data to the individual cellular phone number.

2. A method as recited in claim 1, wherein the electronic data comprises a picture associated with the individual cellular phone number.

3. A method as recited in claim 2, wherein the picture is automatically uploaded to the reply message from a stored photo on the device.

4. A method as recited in claim 2, wherein the request for electronic data is automatically generated from the cellular phone.

5. A method as recited in claim 4, wherein the cellular phone provides a user prompt prior to sending the electronic data.

6. A method as recited in claim 4, wherein the request for electronic data is compatible with one or more of the following protocols: SMS, MMS, email, DIAS.

7. A method as recited in claim 1, wherein identifying an individual cellular phone number for updating into the contact list comprises:
receiving a call on said cellular phone from a cellular phone number not associated with a contact in the contact list; and
prompting the user to add said cellular phone number to contact list.

8. A method as recited in claim 7, further comprising:
prompting the user to request a picture associated with the cellular phone number.

9. A method as recited in claim 1, wherein the electronic data comprises one or more of the following: a picture, music, sound, video or text file associated with the individual cellular phone number.

10. A computer-readable medium containing instructions for controlling a cellular phone to automatically perform a method, the cellular phone including at least one processor for executing the instructions, the method comprising:
identifying an individual cellular phone number for updating into the contact list;
sending from the user's cellular phone a request for electronic data associated with the cellular phone number to a device operating under said cellular phone number;
receiving said request at said device;
sending a reply message from said device, said reply message comprising said requested electronic data;
receiving said reply message at said user's cellular phone; and
updating said contact list by associating said electronic data to the individual cellular phone number.

11. A computer-readable medium as recited in claim 10, wherein the electronic data comprises a picture associated with the individual cellular phone number.

12. A computer-readable medium as recited in claim 11, wherein the instructions are configured such that the picture is automatically uploaded to the reply message from a stored photo on the device.

13. A computer-readable medium as recited in claim 12, wherein the instructions are configured such that the request for electronic data is automatically generated from the cellular phone.

14. A communication system comprising:
a first cellular phone;
a second cellular phone in communication with the first cellular phone over a network;
said first and second cellular phones having a contact application software configured to assimilate data with respect to a plurality of individual cellular phone numbers in a contact list;
the contact application software comprising:
a transmitting module for generating a request for electronic data associated with an individual cellular phone number; and
a receiving module for reading the request for electronic data and associating the electronic data to an individual cellular phone number in the contact list.

15. A system as recited in claim 14, wherein the electronic data comprises a picture file associated with the individual cellular phone number.

16. A system as recited in claim 14, wherein the electronic data comprises one or more of the following: a picture, music, sound, video or text file associated with the individual cellular phone number.

17. A system as recited in claim 15:
wherein the transmitting module is configured to transmit a picture request to a user of the second phone; and
wherein the receiving module on the second phone is configured to automatically upload the picture for transmission back to the first phone.

18. A system as recited in claim 17, wherein the transmitting module on the second phone is configured to transmit the picture in a reply message back to the first phone.

19. A system as recited in claim 18, wherein the receiving module on the first phone is configured to upload the picture to memory located on the first cellular phone and associate the picture to the individual cellular phone number.

20. A system as recited in claim 17, wherein the receiving module is configured to automatically upload the picture to the reply message from a stored picture on the second phone.

21. A system as recited in claim 14, wherein the transmitting module is configured to format the electronic data request according to one or more of the following protocols: SMS, MMS, email, DIAS.

22. A system as recited in claim 14, wherein the receiving module is configured to read the electronic data request formatted in one or more of the following protocols: SMS, MMS, email, DIAS.

23. A system as recited in claim 14, further comprising:
an interface module;
said interface module configured to interface between the receiving module, transmitting module, and data in the contact list.

24. A contacts application for organizing data in a contact list for first and second cellular phones in communication over a network, the contact list comprising a plurality of individual cellular phone numbers, the application comprising:
a transmitting module for generating a request for electronic data associated with an individual cellular phone number; and
a receiving module for reading a reply message comprising the requested electronic data and uploading the picture to memory located on the cellular phone and associate the electronic data to the individual cellular phone number.

25. A contacts application as recited in claim 24:
wherein the electronic data comprises a picture associated with the individual cellular phone number.

26. A contacts application as recited in claim 24, wherein the electronic data comprises one or more of the following: a picture, music, sound, video or text file associated with the individual cellular phone number.

27. A contacts application as recited in claim 24:
wherein the transmitting module is configured to transmit a picture request from the first phone to the second phone; and
wherein the receiving module on the second phone is configured to automatically upload the picture for transmission back to the first phone.

28. A contacts application as recited in claim 27, wherein the transmitting module on the second phone is configured to transmit the picture in a reply message back to the first phone.

29. A contacts application as recited in claim 27, wherein the receiving module is configured to automatically upload the picture to the reply message from a stored picture on the second phone.
